(19) United States
(12) Patent Application Publication
(10) Pub. No.: US 2021/0026813 A1
(43) Pub. Date: Jan. 28, 2021

(54) METHOD FOR QUERYING OR PROCESSING A COMPLETE FILE BY A QUERY LANGUAGE, AND APPARATUS FOR MANAGING THE METHOD

(71) Applicant: Roland Eckl, Forchheim (DE)

(72) Inventor: Roland Eckl, Forchheim (DE)

(21) Appl. No.: 16/928,148

(22) Filed: Jul. 14, 2020

(30) Foreign Application Priority Data
Jul. 23, 2019 (EP) 19187858.6

(51) Int. Cl. G06F 16/182; G06F 16/13; G06F 16/14; G06F 16/11

(52) U.S. Cl. CPC G06F 16/1827; G06F 16/122; G06F 16/144; G06F 16/13

(57) ABSTRACT

A novel and advantageous combination of a data interface (e.g., API endpoint) and a dedicated file endpoint having a common ticket system is presented. Quasi-atomic actions are made possible through the use of (at least) one freshly introduced ticket each that links the two endpoints to one another. Files are addressable using type-specific FileProxies as part of the data model, the respective FileProxies implementing the type-specific handling (e.g., reading, writing, changing, deleting).

The present patent document claims the benefit of European Patent Application No. 19187858.6, filed Jul. 23, 2019, which is hereby incorporated by reference.

### TECHNICAL FIELD

Methods and apparatuses are disclosed for querying or processing files by query languages.

### BACKGROUND

A query language (also request language, retrieval language, search language, search query language, filter language) may refer to a language for searching for information.

The result of a query is a subset of the underlying stock of information.

For example, conventional languages such as SQL (structured query language) are counted as a query language for databases or languages from data analytics (e.g., Sparql, Gremlin, . . . ), but also as modern representatives such as GraphQL in a web setting. A query is contrasted against a type model or scheme. This may be a database scheme, which defines one or more tables having specific fields, or a type model for objects having properties. In both cases, relationships between tables or objects are possible and for the most part exist.

Despite the term “query”, such languages permit not only the simple query but also the manipulation (e.g., generation, alteration, deletion) of data. The scope of language and the functionalities realized thereby follow the CRUD (create, read, update, delete) principle for the most part. Nevertheless, irrespective of the specific function, a request and an associated response are referred to below.

As a rule, a request is transmitted completely and then resolved by one or more “resolvers” and transferred to the response.

Web APIs (application programming interface, e.g. with respect to a web server, cf. also https://en.wikipedia.org/wiki/Web_API), which may be implemented on the server and called by the client side of an application, may be used to make requests, which generate responses (e.g., request/response). In this case too, there is frequently direct interaction with data. In the consideration that follows, the aim is in particular to consider data-centric APIs of this kind, less so resource-centric ones that follow the classical REST (representational state transfer) paradigm. This also includes in particular RPC (remote procedure calls) too; many queries or graph queries are basically standardized queries using RPC.

An example of a method for providing functions, in particular, including the querying of information, within an industrial automation system via a web application may be found in EP 3,438,774 A1.

When reference is made to a query language (QL) below, this includes (e.g., web) APIs having comparable properties.

Query languages and APIs are for the most part suitable for simple or complex requests for data (e.g., records); less so, or not at all, for entire files, however. Handling files in the same way as ordinary data (that is to say, for example, the content of a file as the value of a variable) is disadvantageous in this instance for various reasons.

To begin, a file is ordinarily not a query property, because a data record, (which is dependent on equality with a file transferred as a parameter), is not being sought.

Additionally, a file is not a good component of a response because, as a rule, the responses for query languages (and also data-centric APIs) follow a format that is evaluable and is not a single raw datum. In particular, a query whose response delivers more than one hit does not permit meaningful output of multiple “plain files”, but rather these need to be packaged as a payload into a superordinate structure and possibly also marked separately (“escaped”, e.g., BASE64 encoded). Both additionally lead to more traffic during network transport.

Further, the size of the file(s) may be unknown beforehand. Transmission of the response may take an unexpectedly long time, or the client does not have sufficient resources or interest to receive all files anyway from a specific threshold value upwards.

Also, a file is not a good component of a mutation (e.g., create, update), because the request becomes very large as a result. In the case of most query languages, however, the complete request needs to have been transmitted first in order to be able to begin resolving it in the first place. One or more files would therefore be transmitted as part of the mutation, to possibly discover that, e.g., the rights of the user are not sufficient, or the request does not comply with other constraints. The upload would thus take place as part of the very long-lasting request but would not lead to persistence (e.g., holding of the data over a longer period) at the server end.

Furthermore, the evaluating system needs to have a sufficiently large main memory (or temporary buffer store) in order to accept and buffer-store the entire query with the included file(s).

Because the request is seen as a whole, streaming of the file(s) to the storage location as an integral part of the request is likewise not possible. This would require files to be identifiable/extractable as an integral part of the query on the fly and possibly streamed further directly to the destination (e.g., data carrier, underlying system for file storage, etc.). Similarly, different destination storage for files would not be possible (for example, on the SD cards, internal memory, data structures), because this would be able to be resolved only by the resolve act.

In both directions (reading, writing), the following is true: it is unclear at the time of the request or response whether the opposing party may or wishes to receive all of the data. Similarly, depending on the file size, it is difficult to assess in advance what upload/download strategy would be most suitable (for example, parallel download of single files, sequential loading in an open connection, sequential loading in individual single connections, etc.).

For this reason, files are ordinarily also not handled using query languages at all, or at most indirectly as a retrievable property that e.g. depicts a path to an existing file to which both the client (e.g., requester) and the server (e.g., response handler) have access. The actual file handling itself is not considered. The query itself thus may not generate, delete, or output new files. In this case, there are more likely two independently usable systems that may be synchronized.

A request does not lead to a file being uploaded, however, and blocks further uploads or read access, for example, for the interim. The interaction therefore actually takes place via two independent systems and cannot be regarded as “atomic action”.

Similarly, query languages do not per se allow dynamic files to be represented (for example, a query with specific criteria for which a specific file representation is supposed to be generated and serialized only when required, such as a backup file, a state representation, an export of traces of specific subsystems, etc.).

This is precisely the problem, however: query languages or data-centric APIs have many advantages for flexibly handling data, but do not allow for file handling.

Nevertheless, especially in an industrial setting, many files also exist and are linked to data (and models) (e.g., traces, logs, firmware images, etc.). The aim is thus to obtain the advantages of query languages and at the same time to use these to allow simple and comprehensive file handling.

The problem may be transferred to all APIs at system boundaries, even if the focus in the description lies with query languages and APIs in a web setting, which are consumable from browsers and are therefore based on the HTTP protocol, for example, which may be taken from various RFCs (e.g., version RFC7540 from 2015, but not restricted thereto).

As described earlier on, data and files (e.g., resources) are considered separately from one another in query languages or data-centric APIs today.

Alternatively, resource-based APIs (cf. REST APIs) are more likely used. In particular, REST shifts much complexity to the client, however, and, in the case of more complex requests, for the most part also leads to many individual requests. As such, for example, ODATA (http://www.odata.org/) may be used to perform queries; file access would likewise be possible via the same or a different endpoint. Nevertheless, file sizes for each individual file would need to be queried beforehand using HTTP HEAD, and manipulation (e.g., create, write, delete) would not be possible as a quasi-atomic action. (In this case too, one individual action per file without reference to an ODATA request—a datum is therefore not hard-coupled to a file.)

### SUMMARY AND DESCRIPTION

It is therefore an object of the disclosure to specify a way of allowing the use of APIs and queries and also manipulations on files as a whole.

The scope of the present disclosure is defined solely by the appended claims and is not affected to any degree by the statements within this summary. The present embodiments may obviate one or more of the drawbacks or limitations in the related art.

The method allows a complete file to be queried or processed by a query language via an interface, wherein the file is addressed in an information model as an object, having the following acts: a request received from a client for a file is checked for executability; a ticket is generated that contains information concerning the query and concerning the file; and ticket information about the requesting client is conveyed to the scheduled recipient of the query, wherein the information contained in the ticket may be taken as a basis for the complete file being loaded or processed by the recipient.

The file in question may also be just a part of the actually performed query.

An apparatus for performing a method for querying or processing a complete file by a query language via an interface is also provided. The apparatus may include a processor and/or memory configured to perform the methods disclosed herein. Using the apparatus, the file is addressed in an information model as an object, which apparatus is addressable by both the client and the recipient of the file. Furthermore, after a check for executability of a request received from a client for a file, the apparatus is configured to generate a ticket that contains information concerning the query and concerning the file and convey the ticket with the information about the requesting client to the scheduled recipient of the query, wherein the recipient may take the received information contained in the ticket as a basis for loading or processing the complete file.

A novel and advantageous combination of a data interface (API endpoint) and a dedicated file endpoint having a common ticket system is presented. Quasi-atomic actions are made possible through the use of (at least) one freshly introduced ticket each that links the two endpoints to one another. Files are addressable using type-specific FileProxies as part of the data model, the respective FileProxies implementing the type-specific handling (e.g., reading, writing, changing, deleting).

An interface or else dedicated API endpoint for requests/queries or API calls and a dedicated file endpoint, which may (but does not have to) be on the same physical device, are already known from the prior art of the web API. These endpoints are not indirectly related, however, but rather operate independently of one another.

An information model (or data model) permits interaction with data. The model may have a graph structure. This graph structure facilitates the request. It is thus possible for data that are linked to one another, (e.g., in a tree structure), to be determined by one query where multiple queries would be necessary otherwise (see also, e.g., OPC UA). Files are included as independent objects (known as FileProxies) in this model, which are related to further objects. One object represents a diagnosis buffer, and another object represents a dump of all diagnosis data as a file, for example.

These FileProxy objects are used firstly for presentation in the information model (e.g., in order to query information or to request actions) but also for implementing respective type-specific handling of files (e.g., writing firmware, persisting large blobs—binary large objects—into a database, storing individual files on an SD card or a file system, etc.).

An aspect of the disclosure is a novel ticket system that creates a respective ticket for actions on the information model that have reference to a file.

This system also monitors the life cycle of such actions tied to a ticket, such as the maximum duration of a total action. The API endpoint interface is used to access the information model, which may be provided on a web server.

Files are represented via objects, known as “FileProxies”, which are generated, manipulated, or read as child elements of other elements. The interaction with these proxies masks the actual file interaction, (e.g., constraints are checked, information about the associated file is supplied, etc.). All actions following the CRUD principle (create, read, update, delete/generate, read, write/change, delete) are therefore checked for possibility of execution (“preview” phase) and immediately (delete) or subsequently (all others) executed (“resolve” phase) via the file API via the respective proxy.

Deleting a proxy via the web API automatically also removes its physical counterpart that represents it. Generating, writing, and reading files, on the other hand, generates a ticket in the ticket manager and puts the proxy into a state that reflects that a file interaction via the file API is still outstanding.

As part of the data interaction, the user receives the state and state information as a result of transmission of the properties of the FileProxy as part of the response. These cover constraints when generating/changing, (for example, “Upload 20 Mb max”), or, in the case of desired reading processes, the meta information for the respective file (for example, “file size is 5 Mb”).

This also includes the respective ticket, which is represented at least by a unique ID. Furthermore, information concerning the life of the ticket may be included.

A ticket may be tied to a user session. Only the person who has initiated the ticket may be able to use it at the file API. To this end, the ticket manager manages not only the tickets, and the reference thereof to the relevant FileProxy, but also the life and the association with a user session. The meta information and constraints need to remain stable for as long as there are still tickets open for the action. This means a file (or the form thereof in firmware, file system, etc.) and the FileProxy thereof in the information model is not altered while tickets for read actions therefor are outstanding.

Read actions on the same file may take place in parallel, however.

A write or delete action, on the other hand, is possible only if there are currently no tickets at all open for the file and the proxy thereof.

A separate file endpoint may form a REST interface on a web server, but other solutions, for example an RPC call, would also be conceivable. The file endpoint permits actions using HTTP methods, for example GET for reading and POST for writing, and may have the ticket ID in the path of the HTTP request.

### BRIEF DESCRIPTION OF THE DRAWING

Further advantages and details of the present disclosure are apparent from the exemplary embodiments described below and with reference to the drawing, in which:

FIG. 1 depicts a flowchart for a method according to an embodiment.

It will be realized that the exemplary embodiment within the FIGURE is not meant to be limiting.

### DETAILED DESCRIPTION

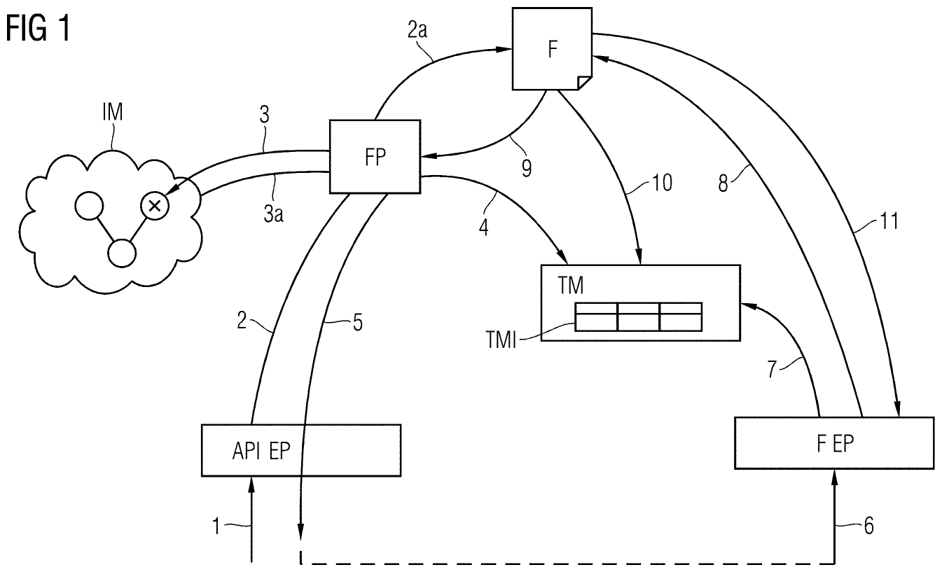

In the exemplary method depicted in FIG. 1, a ticket is checked for validity by the endpoint (API endpoint) via the ticket manager (TM). If the ticket is valid, the desired action is executed via the associated FileProxy (“resolve” phase) and, on successful execution, ultimately receives a positive response. If the outcome is negative, an applicable error code is returned in the header.

An HTTP-POST contains (e.g., exclusively) the file in the request body and provides a response without a body. The POST would be used for generating and writing.

An HTTP-GET does not contain a request body, but rather provides (e.g., exclusively) the file in the response body. The GET would be used for reading.

An HTTP-DELETE contains neither a request body nor a response body. The DELETE is used to return a ticket. (Not to delete a file.)

In the aforementioned “resolve” act, the file is written or read, wherein the payload of the HTTP request may be handed over directly to the destination (e.g., flash memory, file system, database, etc.) in the way that the data arrive at the file endpoint. It is thus not imperative for the whole file to be received completely first, but rather the buffering or direct forwarding may be handled on a type-specific basis by the FileProxy.

Following successful execution, the FileProxy changes to a general default state (e.g., “available”). If an action has been initiated (e.g., writing a file), but it is not supposed to be executed, (e.g., because the file would be larger than the permitted maximum value for the upload that is specified in the response), then the ticket may be deleted using the HTTP method DELETE. The FileProxy is put back into the original state (or removed if the object may first be generated in order to perform “orphan handling” and not to leave behind any orphaned objects in the information model.) The ticket may also be removed automatically if an action is simply not initiated with the ticket against the file API over a defined period.

The exemplary sequence of a quasi-atomic action as depicted in FIG. 1 is described below.

The data endpoint (API endpoint) may be used to display a file. The instructions are described in a kind of “pseudocode”; http code is written in italics.

In act 1, a client makes a request with a query that is ultimately supposed to lead to a file being generated.

Create file (x)

In act 2, the information model (IM) is used to address (x) an object that has been used to model the file. The file is represented by a FileProxy (FP), which performs an initial check to determine whether the action is possible under the current constraints.

The FileProxy (FP) is initially in the “pending” status.

Create FileProxy

Check if File may be added to X

Check environment (user, available space, system state, etc.)

In act 3, if the outcome is positive, the proxy is added to the model.

Add FileProxy to IM (Information Model),

Set state=“pending”

In act 4, a ticket is generated that refers to the FileProxy (FP) and is stored in the ticket manager (TM).

Create Ticket,

Link Ticket to FileProxy

In act 5, the ticket is reported back to the client as part of the response. The representative of the file also contains information about how long the ticket is valid for and what constraints need to be observed (for example, maximum file size).

Return FileProxy Object with Ticket “AFFEAFFE” and Conditions (max. Size, max. Time valid, . . . )

In act 6, the client initiates an HTTP POST to the file endpoint by using the ticket (e.g., as an integral part of the URL).

POST/file/AFFEAFFE http/1.1

Upload File

In act 7, the endpoint checks the ticket for validity and the availability of the FileProxy linked thereto.

Check Ticket

Get FileProxy

In act 8, the proxy is used to finally persist the file, depending on proxy type and requirements, either in one piece, in multiple parts, or in streamed fashion.

Persist through Resolver

In act 9, when the data transfer has concluded, the status on the proxy in the information model is set to the state “available”.

Set state=“available”

In act 10, the ticket is resolved (e.g., removed).

Fulfil ticket “AFFEAFFE”

In act 11, the applicable HTTP status code is used to signal to the client that the action has been concluded successfully.

HTTP 200 OK

Acknowledge Upload

Negative case (not depicted in the FIGURE)
Delete—ticket is deleted
Timeout—ticket is deleted
If necessary, an error code is reported back.

In a further advantageous embodiment, a ticket ID may encode specific variables that permit the time of issue and the order of the tickets to be reconstructed. It is therefore possible to determine, if necessary, whether an unavailable ticket may at least probably have existed previously.

These 16 bytes may yield a 32-character character string in HEX representation, for example the ticket: [4 Bytes=DateTime][8 Bytes=Random Ticket] [4 B.=Counter]

In order to obtain a manipulation-proof solution, it is advantageously possible for at least a part of the ticket ID to be chosen at random (Random). If a symmetric BlockCipher is used (e.g., Feistel for reversible hashing), the variables included in the coding are no longer so easily identifiable. Even if these accompanying variables were to be manipulated, however, there is the whole equivalent in the ticket manager on the server and the ticket is valid for the respective user session. Such additional coding in the ticket ID thus permits better error responses to be provided, if necessary, without adversely affecting security.

In a specific exemplary embodiment, the proposed solution is usable in particular for programmable logic controllers (PLC) having a web-based data interface.

The solution affords some advantages over the previous approach. Actions including a request and associated file handling may be implemented as quasi-atomic actions.

The fact that uploads and downloads via connections take place outside the standard request/response communication of the queries (“out-of-bound”) permits better parallelization.

Large volumes of data as part of a request (“upload”) may be avoided, in particular, if the actual update/generation of the file is impossible with the parameters that are provided concurrently. The order of the parameters is sometimes not always such that the file(s) must first finish.

Similarly, breaking off the entire mutation in order to prevent an upload would be counter-productive in the case of batch requests. Simply breaking off would also provide no detailed information regarding “why not possible”→the respective serialization of the FileProxy is more informative for this.

A further advantage is that flexible quota in regard to parallel file interactions is made possible, if necessary, with different quota depending on the data object to which a file belongs. A firmware transfer is exclusive over all users, data logs as far as X per user and total parallel, etc.

Because the underlying action and determination (e.g., write firmware to flash) is known for every ticket, the transfer of the file may be handled individually.

As noted above, the apparatus may have a processor and/or memory configured to perform the exemplary methods disclosed herein. The processor may include a general processor, digital signal processor, an application specific integrated circuit (ASIC), field programmable gate array (FPGA), analog circuit, digital circuit, combinations thereof, or other now known or later developed processor. The processor may be a single device or combinations of devices, such as associated with a network, distributed processing, or cloud computing.

The memory may be a volatile memory or a non-volatile memory. The memory may include one or more of a read only memory (ROM), random access memory (RAM), a flash memory, an electronic erasable program read only memory (EEPROM), or other type of memory. The memory may be removable from the device 122, such as a secure digital (SD) memory card.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for querying or processing a complete file by a query language via an interface, wherein the file is addressed in an information model as an object, the method comprising:
checking a request received from a client for a file for executability;
generating a ticket comprising information concerning a query and concerning the file;
conveying the information about the requesting client to a scheduled recipient of the query; and
loading or processing the complete file by the scheduled recipient using the conveyed information in the ticket.

2. The method of claim 1, wherein the processing of the file also comprises a fresh creation of the file.

3. The method of claim 1, wherein the information model has a graph structure that depicts relationships of the information and files with one another.

4. The method of claim 3, wherein type-specific FileProxies are addressable as part of the information model,
wherein the respective FileProxies allow type-specific handling to be implemented, and
wherein the type-specific handling comprises one or more of reading, writing, changing, and deleting.

5. The method of claim 4, wherein a FileProxy comprises information regarding a FileProxy state.

6. The method of claim 1, wherein the ticket or the FileProxy comprises information about constraints of the query.

7. The method of claim 6, wherein the constraints of the query relate to a validity period of the ticket or a maximum file size.

8. The method of claim 6, wherein the generated ticket is tied to a user session.

9. The method of claim 1, further comprising:
deactivating the ticket following successful file transmission.

10. The method of claim 1, wherein the file has a state based on which the file is identifiable whether the file is available for querying or processing or whether the querying or processing is currently being performed.

11. The method of claim 1, wherein a central entity contactable by the recipient via file application programming interface (API) and data API is used for generating and managing the ticket.

12. The method of claim 1, wherein the generated ticket is provided with a unique ticket identifier, and
wherein, in return, at least a part of the ticket identifier is chosen at random and a part of the ticket identifier comprises variables permitting a time of issue and an order of the ticket to be reconstructed.

13. The method of claim 1, wherein the method is used for a programmable logic controller having a web-based data interface.

14. An apparatus for querying or processing a complete file by a query language via an interface, wherein the file is addressed in an information model as an object, which apparatus is addressable by both a client and a recipient of the file, the apparatus comprising:
a processor configured to:
generate a ticket comprising information concerning a query and concerning the file, after a check for executability of a request is received from a client for the file; and
convey the ticket with the information about the requesting client to a scheduled recipient of the query,
wherein the recipient is configured to take the received information in the ticket as a basis for loading or processing the complete file.

15. The apparatus of claim 14, wherein the processing of a file also comprises a fresh creation of the file.

16. The apparatus of claim 14, wherein the information model has a graph structure that depicts relationships of the files with one another.

17. The apparatus of claim 14, wherein the ticket comprises information about constraints of the query.

18. The apparatus of claim 17, wherein the constraints relate to a validity period of the ticket or a maximum file size.

19. The apparatus of claim 14, wherein the generated ticket is tied to a user session.

20. The apparatus of claim 14, wherein the apparatus is configured to deactivate the ticket following successful file transmission to the recipient.

21. The apparatus of claim 14, wherein the ticket generated by the apparatus is provided with a unique ticket identifier, and
wherein, in return, at least a part of the ticket identifier is chosen at random and a part of the ticket identifier comprises variables permitting a time of issue and an order of the ticket to be reconstructed.
